(19) United States
(12) Patent Application Publication
(10) Pub. No.: US 2017/0040803 A1
(43) Pub. Date: Feb. 9, 2017

(54) Portable Power Supply Assembly

(71) Applicant: Winston Peters, Whitehouse Station, NJ (US)

(72) Inventor: Winston Peters, Whitehouse Station, NJ (US)

(21) Appl. No.: 14/821,356

(22) Filed: Aug. 7, 2015

(51) Int. Cl. H02J 5/00; H02M 7/44

(52) U.S. Cl. CPC H02J 5/00; H02M 7/44

(57) ABSTRACT

A portable power supply assembly includes a power strip that may be electrically coupled to a plurality of extrinsic electrical devices. A battery pack is removably coupled to the power strip such that the battery pack is electrically coupled to the power strip. The battery pack may insertably receive a plurality of batteries. A control circuit is positioned within the power strip and the control circuit is electrically coupled to the power strip. Thus, the control circuit allows the plurality of batteries to supply power to the extrinsic electrical device.

### BACKGROUND OF THE DISCLOSURE

### Field of the Disclosure

The disclosure relates to power supply devices and more particularly pertains to a new power supply device for facilitating an AC electrical device to be powered by disposable DC batteries.

### SUMMARY OF THE DISCLOSURE

An embodiment of the disclosure meets the needs presented above by generally comprising a power strip that may be electrically coupled to a plurality of extrinsic electrical devices. A battery pack is removably coupled to the power strip such that the battery pack is electrically coupled to the power strip. The battery pack may insertably receive a plurality of batteries. A control circuit is positioned within the power strip and the control circuit is electrically coupled to the power strip. Thus, the control circuit allows the plurality of batteries to supply power to the extrinsic electrical device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a portable power supply assembly according to an embodiment of the disclosure.

FIG. 2 is a top view of an embodiment of the disclosure.

FIG. 3 is a front view of an embodiment of the disclosure.

FIG. 4 is a right side view of an embodiment of the disclosure.

FIG. 5 is a perspective view of an alternative embodiment of the disclosure.

### DESCRIPTION OF THE PREFERRED EMBODIMENT

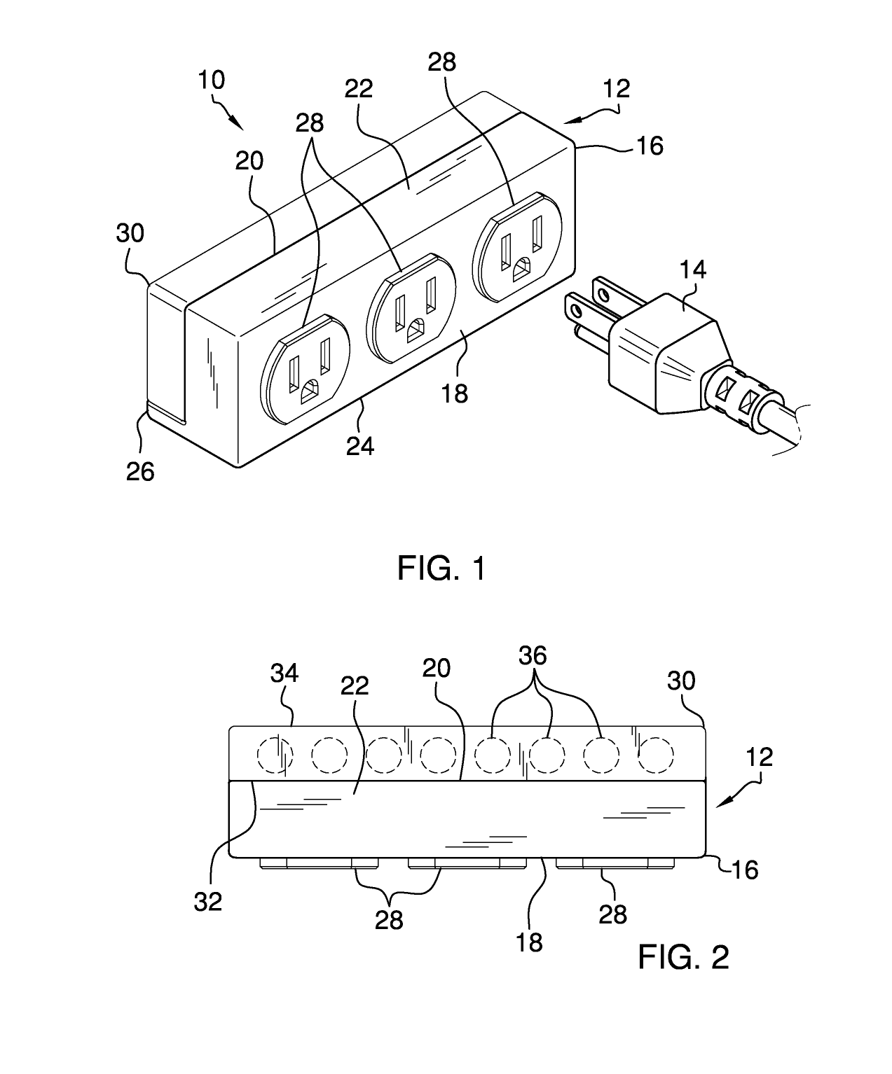

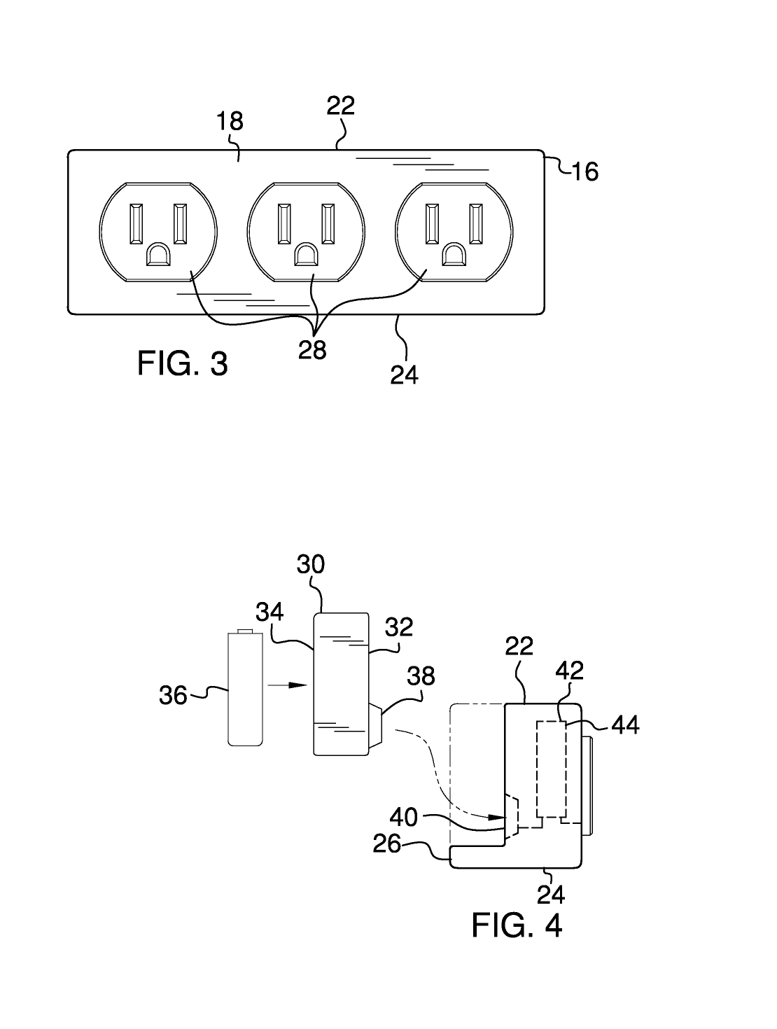

With reference now to the drawings, and in particular to FIGS. 1 through 5 thereof, a new power supply device embodying the principles and concepts of an embodiment of the disclosure and generally designated by the reference numeral 10 will be described.

As best illustrated in FIGS. 1 through 5, the portable power supply assembly 10 generally comprises a power strip 12 that may be electrically coupled to a plurality of extrinsic electrical devices 14. The extrinsic electrical devices 14 may each comprise an AC electrical device with an electrical current draw of less than approximately 50 mA. The power strip 12 comprises a housing 16 that has a front side 18, a back side 20, a top side 22 and a bottom side 24. The back side 20 has a foot 26 extending away from the back side 20. The foot 26 is aligned with the bottom side 24 and the foot 26 is coextensive with the housing 16.

A plurality of power ports 28 is provided and each of the power ports 28 is coupled to front side 18. Each of the power ports 28 may be electrically coupled to one of the extrinsic electrical devices 14. The power ports 28 are spaced apart from each other and distributed along the front side 18. Each of the power ports 28 comprises a female electrical outlet.

A battery pack 30 is removably coupled to the power strip 12 such that the battery pack 30 is electrically coupled to the power strip 12. The battery pack 30 has a forward side 32 and a rearward side 34. The rearward side 34 is open such that the rearward side 34 may insertably receive a plurality of batteries 36. Each of the batteries 36 may comprise disposable batteries such as AA cell, C cell or D cell batteries and each of the batteries may supply a DC voltage.

The forward side 32 has a plug 38 extending outwardly therefrom. The plug 38 is electrically coupled to the batteries 36 when the batteries 36 are positioned within the battery pack 30. The battery pack 30 is positioned such that the forward side 32 abuts the back side 20 of the housing 16 having the battery pack 30 resting on the foot 26. A socket 40 is coupled to the back side 20 of the housing 16 and the socket 40 is electrically coupled to each of the power ports 28. The plug 38 engages the socket 40 such that the battery pack 30 is electrically coupled to the power ports 28.

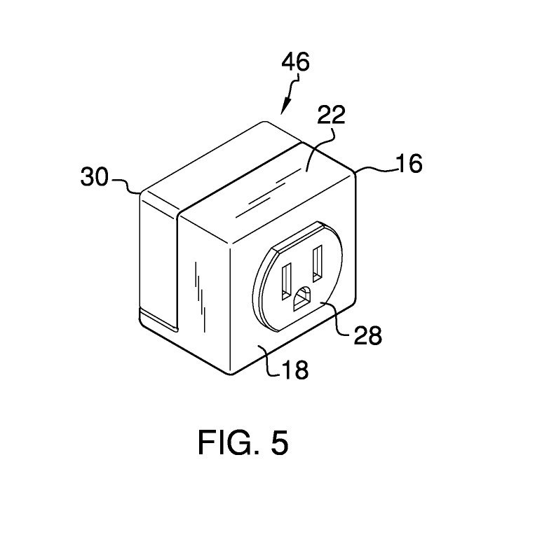

A control circuit 42 is positioned within the power strip 12 and the control circuit 42 is electrically coupled to the power strip 12. The control circuit 42 comprises an inverter 44 and the inverter 44 is electrically coupled between the socket 40 and each of the power ports 28. The inverter 44 converts a direct current voltage into an alternating current voltage. Thus, the inverter 44 facilitates the plurality of batteries 36 to supply electrical power to the extrinsic electrical devices 14. In an alternative embodiment 46 as shown in FIG. 5, the housing 16 may have a single power port 28.

In use, the batteries 36 are positioned within the battery pack 30. The battery pack 30 is electrically coupled to the housing 16. The extrinsic electrical devices 14 are each plugged into an associated one of the power ports 28. The batteries 36 are replaced when the batteries 36 become depleted. The power strip 12 is utilized when no AC electricity is available.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable power supply assembly comprising:
a power strip being configured to be electrically coupled to a plurality of extrinsic electrical devices;
a battery pack being removably coupled to said power strip such that said battery pack is electrically coupled to said power strip, said battery pack being configured to insertably receive a plurality of batteries; and
a control circuit being positioned within said power strip, said control circuit being electrically coupled to said power strip wherein said control circuit is configured to allow the plurality of batteries to supply power to the extrinsic electrical device.

2. The assembly according to claim 1, wherein said power strip comprises a housing having a front side, a back side, a top side and a bottom side, said back side having a foot extending away from said back side, said foot being aligned with said bottom side, said foot being coextensive with said housing.

3. The assembly according to claim 2, further comprising a plurality of power ports, each of said power ports being coupled to front side, each of said power ports being configured to be electrically coupled to one of the extrinsic electrical devices, said power ports being spaced apart from each other and distributed along said front side.

4. The assembly according to claim 3, further comprising a socket being coupled to said back side, said socket being electrically coupled to each of said power ports.

5. The assembly according to claim 1, wherein said battery pack has a forward side and a rearward side, said rearward side being open thereby facilitating said battery pack to insertably receive the plurality of batteries, said forward side having a plug extending outwardly therefrom, said plug being configured to be electrically coupled to the batteries when the batteries are positioned within said battery pack.

6. The assembly according to claim 5, wherein:
said power strip has a back side, a foot, a socket and a plurality of power ports; and
said battery pack is positioned such that said forward side abuts said back side of said housing having said battery pack resting on said foot, said plug engaging said socket such that said battery pack is electrically coupled to said power ports.

7. The assembly according to claim 1, wherein:
said power strip has a socket and a plurality of power ports; and
said control circuit comprises an inverter, said inverter being electrically coupled between said socket and each of said power ports, said inverter being configured to convert a direct current voltage into an alternating current voltage thereby facilitating the plurality of batteries to supply electrical power to the extrinsic electrical devices.

8. A portable power supply assembly comprising:
a power strip being configured to be electrically coupled to a plurality of extrinsic electrical devices, said power strip comprising:
a housing having a front side, a back side, a top side and a bottom side, said back side having a foot extending away from said back side, said foot being aligned with said bottom side, said foot being coextensive with said housing,
a plurality of power ports, each of said power ports being coupled to front side, each of said power ports being configured to be electrically coupled to one of the extrinsic electrical devices, said power ports being spaced apart from each other and distributed along said front side, and
a socket being coupled to said back side, said socket being electrically coupled to each of said power ports;
a battery pack being removably coupled to said power strip such that said battery pack is electrically coupled to said power strip, said battery pack having a forward side and a rearward side, said rearward side being open wherein said rearward side is configured to insertably receive a plurality of batteries, said forward side having a plug extending outwardly therefrom, said plug being configured to be electrically coupled to the batteries when the batteries are positioned within said battery pack, said battery pack being positioned such that said forward side abuts said back side of said housing having said battery pack resting on said foot, said plug engaging said socket such that said battery pack is electrically coupled to said power ports; and
a control circuit being positioned within said power strip, said control circuit being electrically coupled to said power strip, said control circuit comprising an inverter, said inverter being electrically coupled between said socket and each of said power ports, said inverter being configured to convert a direct current voltage into an alternating current voltage thereby facilitating the plurality of batteries to supply electrical power to the extrinsic electrical devices.
